(19) United States
(12) Patent Application Publication
(10) Pub. No.: US 2025/0229819 A1
(43) Pub. Date: Jul. 17, 2025

(54) FORKLIFT

(71) Applicant: DJANGO ROBOTICS SHENZHEN CO., LTD., Shenzhen (CN)

(72) Inventors: Weilin HU, Shenzhen (CN); Yuezhong WU, Shenzhen (CN)

(21) Appl. No.: 19/171,268

(22) Filed: Apr. 6, 2025

Related U.S. Application Data
(63) Continuation of application No. PCT/CN2024/070747, filed on Jan. 5, 2024.

(51) Int. Cl. B62B 3/06

(52) U.S. Cl. CPC B62B 3/06

(57) ABSTRACT

The present invention discloses a forklift, referring to the technical field of handling equipment. The disclosed forklift comprises: a forklift body, a floating connection assembly, a connecting rod mechanism and a load-bearing wheel; the floating connection assembly is arranged on the forklift body, one end of the connecting rod mechanism is hinged to the floating connection assembly, and the other end of the connecting rod mechanism is hinged to the load-bearing wheel to support the load-bearing wheel; the floating connection assembly has a first state and a second state; when in the first state, the floating connection assembly can float relative to the forklift body in a vertical direction; when in the second state, the floating connection assembly is relatively fixed to the forklift body to limit the floating of the connecting rod mechanism and the load-bearing wheel relative to the forklift body in the vertical direction.

### CROSS-REFERENCE TO RELATED APPLICATIONS

The present application is a continuation of International Patent Application No. PCT/CN2024/070747 filed on Jan. 5, 2024, the disclosure of which is hereby incorporated by reference in its entirety.

### TECHNICAL FIELD

The present invention relates to the technical field of handling equipment, in particular to a forklift.

### BACKGROUND

As small and medium-sized handling equipment, forklifts are widely used for loading and unloading of goods at receiving and dispatching stations, as well as for handling operations between various processes in a workshop. Forklifts usually have two fork arms, and the front end of the fork arm is provided with load-bearing wheels, which are supported by a connecting rod mechanism. During the operation of the forklift, with the support of the connecting rod mechanism, the load-bearing wheels will protrude from the lower surface of the fork arm and contact the ground.

When the forklift is moving or using the forklift to transport goods, the load-bearing wheels on the fork arm will inevitably contact obstacles or goods, which will hinder the load-bearing wheels and even cause damage to the load-bearing wheels or goods.

### SUMMARY

The present invention discloses a forklift to solve the problem in the related art that obstacles or goods may hinder the load-bearing wheels during the movement of the forklift or when the forklift is used to transport goods, and may even cause damage to the load-bearing wheels or goods.

In order to solve the above technical problem, the present invention is implemented as follows:
The technical solution of the present invention discloses a forklift, which comprises: a forklift body, a floating connection assembly, a connecting rod mechanism and a load-bearing wheel;
the floating connection assembly is arranged on the forklift body, one end of the connecting rod mechanism is hinged to the floating connection assembly, and the other end of the connecting rod mechanism is hinged to the load-bearing wheel to support the load-bearing wheel;
the floating connection assembly has a first state and a second state;
when in the first state, the floating connection assembly can float relative to the forklift body in a vertical direction so that the connecting rod mechanism and the load-bearing wheel float relative to the forklift body in the vertical direction;
when in the second state, the floating connection assembly is relatively fixed to the forklift body to limit the floating of the connecting rod mechanism and the load-bearing wheel relative to the forklift body in the vertical direction.

In an implementation, the floating connection assembly comprises a sliding support seat and a slider;
the sliding support seat is slidably connected to the forklift body, and can slide relative to the forklift body in the vertical direction, two opposite side walls of the sliding support seat are respectively provided with a strip hole, and the strip hole extends in the vertical direction; one end of the connecting rod mechanism is hinged to the slider, and the slider is provided with a rotating shaft, two ends of the rotating shaft are respectively inserted into the two strip holes so that the slider can slide relative to the sliding support seat in the vertical direction;
the sliding support seat has a first position and a second position relative to the forklift body, when in the first position, the strip hole has a space for the rotating shaft to slide, and when in the second position, a hole wall of each of the strip holes abuts against the rotating shaft to limit the sliding of the rotating shaft.

In an implementation, the floating connection assembly further comprises a driving member, the driving member is arranged on the forklift body and is connected to the sliding support seat so as to drive the sliding support seat to switch between the first position and the second position.

In an implementation, an output end of the driving member is provided with a hinge shaft, the sliding support seat is provided with an axis hole, the driving member and the sliding support seat are hinged by the fit between the hinge shaft and the axis hole.

In an implementation, one of the sliding support seat and the forklift body is provided with a sliding groove, and the other is provided with a sliding rail, the sliding groove and the sliding rail extend in the vertical direction and form a sliding fit.

In an implementation, the floating connection assembly further comprises a shaft sleeve, the shaft sleeve is respectively sleeved onto the both ends of the rotating shaft and is rotatably connected to the rotating shaft, and an outer side of the shaft sleeve is in sliding fit with the strip hole.

In an implementation, the forklift further comprises a fork arm, the fork arm is arranged corresponding to the connecting rod mechanism, and the load-bearing wheel is used to support the fork arm;
the connecting rod mechanism is hinged to the fork arm, and can raise and lower synchronously with the fork arm relative to the forklift body.

In an implementation, the connecting rod mechanism comprises a first connecting rod, a second connecting rod and a load-bearing wheel bracket;
the first connecting rod is respectively hinged to the slider and the fork arm, two ends of the second connecting rod are respectively hinged to the first connecting rod and the load-bearing wheel bracket, the load-bearing wheel bracket is respectively hinged to the fork arm and the load-bearing wheel.

In an implementation, the forklift further comprises an auxiliary support wheel, the auxiliary support wheel is arranged at the bottom of the forklift body and/or the fork arm.

In an implementation, the forklift comprises two or more connecting rod mechanisms, the number of the floating connection assembly and the load-bearing wheel is equal to the number of the connecting rod mechanism, each load-bearing wheel is hinged to the floating connection assembly via the connecting rod mechanism.

The technical solution adopted by the present invention can achieve the following technical effects:

The forklift disclosed in the technical solution of the present invention improves the relevant technology, by setting a floating connection assembly on the forklift body, the load-bearing wheel is hinged to the floating connection assembly through a connecting rod mechanism. When in the first state, the floating connection assembly can float relative to the forklift body in the vertical direction so that the connecting rod mechanism and the load-bearing wheel float relative to the forklift body in the vertical direction, thereby the load-bearing wheel can avoid obstacles or goods by floating, and avoid the problem of rigid contact between the load-bearing wheels and obstacles or goods, which may cause damage to the load-bearing wheels or goods; when in the second state, the floating connection assembly is relatively fixed to the forklift body to limit the floating of the connecting rod mechanism and the load-bearing wheel relative to the forklift body in the vertical direction, so that the load-bearing wheels can be stably supported on the ground.

### BRIEF DESCRIPTION OF DRAWINGS

FIG. 1 is a schematic diagram of the structure of the forklift disclosed in an embodiment of the present invention;

FIG. 2 is a schematic diagram of the structure of the forklift disclosed in an embodiment of the present invention;

FIG. 3 is a schematic diagram of the structure of the forklift disclosed in an embodiment of the present invention;

FIG. 4 is a schematic diagram of the structure of the forklift disclosed in an embodiment of the present invention;

FIG. 5 is a schematic diagram of the structure of the forklift disclosed in an embodiment of the present invention;

FIG. 6 is a schematic diagram of the structure of the pallet disclosed in an embodiment of the present invention.

### REFERENCE NUMERALS

100—forklift, 110—forklift body, 111—sliding rail, 120—floating connection assembly, 121—sliding support seat, 1211—strip holes, 1212—sliding groove, 122—slider, 1221—rotating shaft, 123—driving member, 1231—hinge shaft, 124—shaft sleeve, 130—connecting rod mechanism, 131—first connecting rod, 132—second connecting rod, 133—load-bearing wheel bracket, 140—load-bearing wheel, 150—fork arm, 160—auxiliary support wheel;
200—pallet, 210—reinforcement rib.

### DETAILED DESCRIPTION

In order to make the purpose, technical solution and advantages of the present invention clearer, the technical solution of the present invention will be clearly and completely described below in conjunction with the specific embodiments of the present invention and the corresponding drawings. Obviously, the described embodiments are only part of the embodiments of the present invention, not all of the embodiments. Based on the embodiments of the present invention, all other embodiments obtained by those skilled in the art without making creative work are within the scope of protection of the present invention.

The terms “first”, “second”, etc. in the specification and claims of the present invention are used to distinguish similar objects, and are not used to describe a specific order or sequence. It should be understood that the numbers used in this way can be interchangeable when appropriate, so that the embodiments of the present invention can be implemented in an order other than those illustrated or described herein, and the objects distinguished by “first”, “second”, etc. are generally of one type, and the number of objects is not limited. For example, the first object can be one or more. In addition, “and/or” in the specification and claims represents at least one of the associated objects, and the character “/” generally represents that the objects associated with each other are in an “or” relationship.

The following is a detailed description of the technical solutions disclosed in various embodiments of the present invention in conjunction with the accompanying drawings.

In the related art, the forklift 100 has a fork arm 150 and a load-bearing wheel 140 arranged at the front end of the fork arm 150. When the forklift 100 is in operation, the load-bearing wheel 140 at the front end of the fork arm 150, supported by the connecting rod mechanism 130, protrudes from the bottom surface of the fork arm 150 and contacts the ground, so as to improve the load capacity of the forklift 100. When the forklift 100 is moving or carrying goods, the load-bearing wheel 140 at the front end of the fork arm 150 will inevitably contact with obstacles or goods. Due to the support of the connecting rod mechanism 130, the load-bearing wheel 140 and the obstacle or goods will be in rigid contact, which may easily cause damage to the load-bearing wheel 140 or the goods.

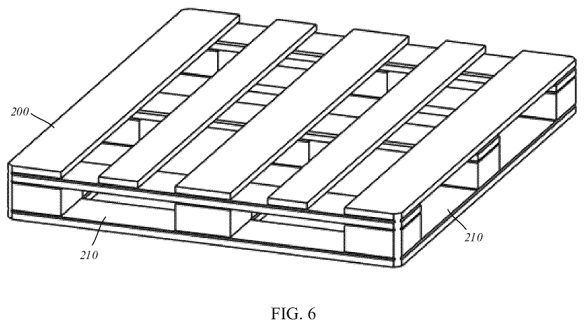

For example, please refer to FIG. 6, when the forklift 100 is transporting the pallet 200, it is necessary to extend the fork arm 150 into the socket of the pallet 200, and then control the fork arm 150 to lift the pallet 200 off the ground, so as to transport the pallet 200 and the goods on the pallet 200. Since the socket of the pallet 200 is provided with a reinforcing rib 210, the reinforcing rib 210 will hinder the load-bearing wheel 140, and the load-bearing wheel 140 and the pallet 200 are prone to rigid contact and damage.

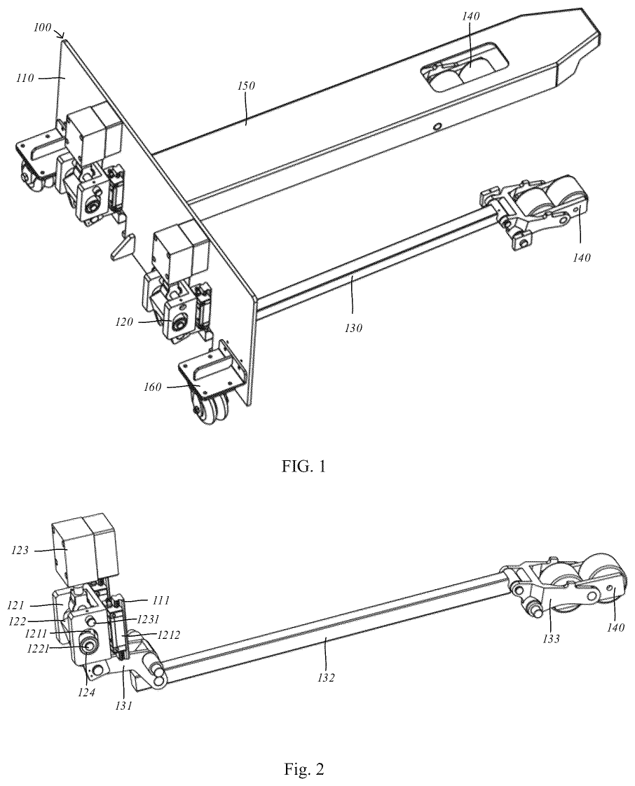

In response to the above problems, please refer to FIG. 1 to FIG. 6, an embodiment of the present invention discloses a forklift 100. The disclosed forklift 100 can be an electric forklift, and the electric forklift can include an unmanned forklift and a manual forklift; the forklift 100 can specifically include a forklift body 110, a floating connection assembly 120, a connecting rod mechanism 130 and a load-bearing wheel 140.

In this embodiment, the forklift body 110 is the main frame of the forklift 100. The forklift body 110 is provided with components such as a hydraulic cylinder and a driving wheel. The hydraulic cylinder is used to drive the fork arm 150 and the connecting rod mechanism 130 to rise and fall in the vertical direction to lift or lower the goods, and the driving wheel is used to realize the movement and steering functions of the forklift 100.

The floating connection assembly 120 is provided on the forklift body 110, and can be assembled with the forklift body 110 by bolt connection, welding, clamping, etc. The connecting rod mechanism 130 is used to support the load-bearing wheel 140. The connecting rod mechanism 130 can control the swing position of the load-bearing wheel 140 through its own rotation and translation, so that the load-bearing wheel 140 can keep in contact with the ground at different heights. One end of the connecting rod mechanism 130 is hinged to the floating connection assembly 120, and the other end of the connecting rod mechanism 130 is hinged to the load-bearing wheel 140, and the hinge connection can be realized by the fit between the shaft and the hole.

The floating connection assembly has a first state and a second state, in the first state, the floating connection assembly 120 can float relative to the forklift body 110 in the vertical direction, since one end of the connecting rod mechanism 130 is hinged to the floating connection assembly 120, the connecting rod mechanism 130 and the load-bearing wheel 140 can also float relative to the forklift body 110 in the vertical direction. When the load-bearing wheel 140 encounters an obstacle, the obstacle will apply a thrust to the load-bearing wheel 140, so that the load-bearing wheel 140 and the connecting rod mechanism 130 float upward in the vertical direction, thereby achieving the purpose of avoiding the obstacle. There will be no rigid contact between the load-bearing wheel 140 and the obstacle, which avoiding the problem of damage to the load-bearing wheel 140 and improving durability.

Taking the transport of pallet 200 as an example, in the process of the fork arm 150 extending into the socket of the pallet 200, the load-bearing wheel 140 will contact the reinforcement rib 210 of the pallet 200. Under the push of the reinforcement rib 210, the load-bearing wheel 140 floats upward in the vertical direction to increase the clearance from the ground, thereby avoiding the reinforcement rib 210, so that the fork arm 150 and the load-bearing wheel 140 can be smoothly extended into the socket of the pallet 200. In this process, since there is no rigid contact between the load-bearing wheel 140 and the reinforcement rib 210, the problem of damage to the load-bearing wheel 140 and the reinforcement rib 210 is avoided.

Since the load-bearing wheel 140 cannot, when it is floating, provide support for the forklift 100, in order to ensure that the load-bearing wheel 140 can be stably supported on the ground during operation, the floating connection assembly 120 can be switched to the second state. In the second state, the floating connection assembly 120 is relatively fixed to the forklift body 110, thereby limiting the floating of the connecting rod mechanism 130 and the load-bearing wheel 140 relative to the forklift body 110 in the vertical direction, so that the load-bearing wheel 140 can be stably in contact with the ground.

By switching the floating connection assembly 120 between the first state and the second state, the floating obstacle avoidance function of the load-bearing wheel 140 can be realized, and also the normal load-bearing function of the load-bearing wheel 140 can be realized, which greatly improves the flexibility of the forklift 100.

It should be noted that the floating connection assembly 120 can float relative to the forklift body 110 in the vertical direction. The floating connection assembly 120 can specifically achieve floating by the fit between the sliding groove and the sliding rail, or by the compression and rebound of the elastic member.

For example, the floating connection assembly 120 may include a sliding groove and a sliding rail, the sliding rail may be fixedly arranged on the forklift body 110, the sliding groove and the sliding rail may slide relative to each other in the vertical direction to achieve the floating function, and the sliding groove is hinged with the connecting rod mechanism 130, so as to achieve the floating of the connecting rod mechanism 130 and the load-bearing wheel 140; when floating is not required, the sliding groove and the sliding rail may be locked to limit the relative sliding of the sliding groove and the sliding rail.

Alternatively, the floating connection assembly 120 may also include a sleeve, a sleeve rod and an elastic member. The sleeve can be fixed on the forklift body 110, the sleeve rod and the elastic member are inserted into the sleeve, and the elastic member is elastically supported on the sleeve rod and the bottom wall of the sleeve, so that the sleeve rod can elastically move within the sleeve to achieve a floating function. The sleeve rod is hinged to the connecting rod mechanism 130, thereby achieving floating of the connecting rod mechanism 130 and the load-bearing wheel 140; when floating is not required, the sleeve rod and the sleeve can be locked to limit the relative movement of the sleeve rod and the sleeve.

As described above, it can be known that the forklift 100 disclosed in the technical solution of the present invention improves the related art. By arranging a floating connection assembly 120 on the forklift body 110, the load-bearing wheel 140 is hinged to the floating connection assembly 120 through the connecting rod mechanism 130. When the floating connection assembly 120 is in the first state, it can float relative to the forklift body 110 in the vertical direction, so that the connecting rod mechanism 130 and the load-bearing wheel 140 float relative to the forklift body 110 in the vertical direction, so that the load-bearing wheel 140 can avoid obstacles or goods by floating, and avoid the problem of rigid contact between the load-bearing wheel 140 and the obstacle or goods, which may cause damage to the load-bearing wheel 140 or the goods; when the floating connection assembly 120 is in the second state, it will be relatively fixed to the forklift body 110 to limit the floating of the connecting rod mechanism 130 and the load-bearing wheel 140 relative to the forklift body 110 in the vertical direction, so that the load-bearing wheel 140 can be stably supported on the ground.

In some optional embodiments, as shown in FIG. 1 and FIG. 2, the floating connection assembly 120 may include a sliding support seat 121 and a slider 122, the sliding support seat 121 is slidably connected to the forklift body 110 and can slide relative to the forklift body 110 in the vertical direction. The sliding support seat 121 may be U-shaped, and two opposite side walls of the sliding support seat 121 are respectively provided with strip holes 1211, which extend in the vertical direction.

The slider 122 is arranged in the sliding support seat 121. The slider 122 is provided with a rotating shaft 1221. Both ends of the rotating shaft 1221 protrude from the slider 122 and are respectively through in the two strip holes 1211, so that the slider 122 can slide along the extension direction (i.e., the vertical direction) of the strip holes 1211. One end of the connecting rod mechanism 130 is hinged to the slider 122, which can be realized by the fit between the shaft and the hole. Since the slider 122 can slide along the extension direction (i.e., the vertical direction) of the strip holes 1211, the connecting rod mechanism 130 and the load-bearing wheel 140 can also float along the extension direction (i.e., the vertical direction) of the strip holes 1211.

For different usage scenarios, the load-bearing wheel 140 needs to have two states: floating and non-floating, which can be achieved by controlling the position of the sliding support seat 121 relative to the forklift body 110. Specifically, the sliding support seat 121 has a first position and a second position relative to the forklift body 110. When in the first position, the strip hole 1211 has a space for the rotating shaft 1221 to slide, and the slider 122 can slide relative to the sliding support seat 121 in the vertical direction, so that the connecting rod mechanism 130 and the load-bearing wheel 140 can float in the vertical direction. When the sliding support seat 121 switches to the second position by sliding, the hole wall of the strip hole 1211 abuts against the rotating shaft 1221 to limit the sliding of the rotating shaft 1221, and the slider 122 cannot slide relative to the sliding support seat 121 in the vertical direction, so that the connecting rod mechanism 130 and the load-bearing wheel 140 cannot float in the vertical direction.

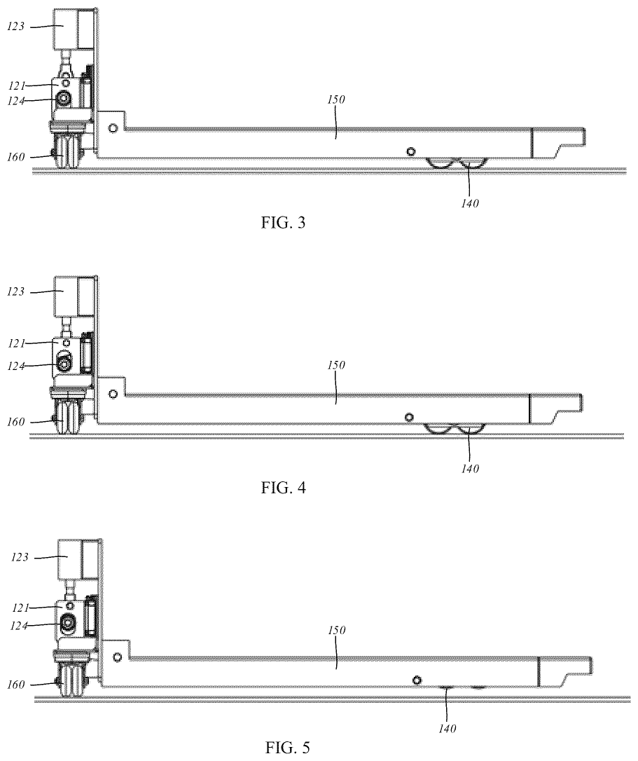

For example, in the vertical direction, the first position can be higher than the second position. As shown in FIG. 4, when the sliding support seat 121 is in the first position, the rotating shaft 1221 of the slider 122 is located at the lower part of the strip hole 1211, and the upper part of the strip hole 1211 has a space for the rotating shaft 1221 to slide, so that the slider 122 can slide relative to the sliding support seat 121 in the vertical direction. As shown in FIG. 5, the slider 122 slides upward and abuts against the upper part of the strip hole 1211, and stops sliding. During the sliding process of the slider 122, the load-bearing wheel 140 floats upward accordingly, and the clearance from the ground increases, so that obstacles can be crossed. As shown in FIG. 3, the sliding support seat 121 is lowered to the second position, and the position of the strip hole 1211 is also lowered. At this time, the rotating shaft 1221 of the slider 122 is located at the upper part of the strip hole 1211 and cannot slide, so that the load-bearing wheel 140 cannot float either, thus the load-bearing wheel 140 can be stably supported on the ground.

Further, as shown in FIG. 1 to FIG. 5, the switching of the sliding support seat 121 between the first position and the second position can be manually controlled or mechanically controlled. Taking mechanical control as an example, the floating connection assembly 120 can also include a driving member 123, which is arranged on the forklift body 110 and can be fixed by welding, bolt connection, etc. The driving member 123 can be a motor, a cylinder, a hydraulic cylinder, etc. The driving member 123 is connected to the sliding support seat 121 to drive the sliding support seat 121 to switch between the first position and the second position.

Further, as shown in FIG. 1 to FIG. 2, the driving member 123 and the sliding support seat 121 can be fixedly connected or movably connected. Taking the movabe connection as an example, the output end of the driving member 123 is provided with a hinge shaft 1231, the sliding support seat 121 is provided with an axial hole, the hinge shaft 1231 is passed through the axial hole, and the driving member 123 and the sliding support seat 121 are hinged by the fit between the hinge shaft 1231 and the axial hole. By adopting the above-mentioned hinged method, when there is an assembly error between the driving member 123 and the sliding support seat 121, or when there are forces in multiple directions between the driving member 123 and the sliding support seat 121, a certain amount of interference can be made by the relative rotation to avoid the problems of jamming and deformation when the driving member 123 and the sliding support seat 121 move relative to each other.

In some optional embodiments, as shown in FIG. 1 to FIG. 5, the sliding support seat 121 and the forklift body 110 can slide relative to each other, which can be achieved by the fit between the sliding groove 1212 and the sliding rail 111. Specifically, the sliding groove 1212 can be set on one side of the sliding support seat 121, and the sliding rail 111 can be set on the forklift body 110, or the sliding rail 111 can be set on one side of the sliding support seat 121, and the sliding groove 1212 can be set on the forklift body 110, the sliding groove 1212 and the sliding rail 111 extend in the vertical direction and form a sliding fit, so that the sliding support seat 121 can switch between the first position and the second position.

Further, as shown in FIG. 1 to FIG. 5, in order to avoid the problem of shaking when the rotating shaft 1221 and the strip hole 1211 are in sliding fit, shaft sleeves 124 can be respectively provided at both ends of the rotating shaft 1221, the outer diameter of the shaft sleeve 124 matches the inner diameter of the strip hole 1211, so that the outer side of the shaft sleeve 124 is just attached to the inner side of the strip hole 1211, and in sliding fit with the inner side of the strip hole 1211, thereby reducing the problem of shaking.

In addition, the slider 122 is hinged to the connecting rod mechanism 130, and the sleeve 124 and the rotating shaft 1221 are also assembled in a rotating connection manner, so as to further reduce the interference between the slider 122, the sliding support seat 121 and the connecting rod mechanism 130.

Further, as shown in FIG. 1, the forklift 100 may also include a fork arm 150, the number of fork arms 150 may be one, two, or more than two, which may be selected according to the actual handling requirements. The fork arm 150 is arranged corresponding to the connecting rod mechanism 130, and a chamber for accommodating the connecting rod mechanism 130 and the load-bearing wheel 140 is arranged in the fork arm 150, the load-bearing wheel 140 is arranged at the front end of the fork arm 150 for supporting the fork arm 150.

The connecting rod mechanism 130 is hinged to the fork arm 150, and can be raised and lowered synchronously with the fork arm 150 relative to the forklift body 110. When the connecting rod mechanism 130 and the fork arm 150 are lifted relative to the forklift body 110, the height of the fork arm 150 from the ground increases. At this time, the connecting rod mechanism 130 drives the load-bearing wheel 140 to swing toward the direction close to the ground, so that the load-bearing wheel 140 always keeps in contact with the ground; when the connecting rod mechanism 130 and the fork arm 150 are lowered relative to the forklift body 110, the height of the fork arm 150 from the ground decreases. At this time, the connecting rod mechanism 130 drives the load-bearing wheel 140 to swing away from the ground, so that the part of the load-bearing wheel 140 that is facing away from the ground is retracted into the chamber of the fork arm 150 to avoid affecting the normal descent of the fork arm 150.

Further, as shown in FIG. 1 and FIG. 2, the connecting rod mechanism 130 may include a first connecting rod 131, a second connecting rod 132 and a load-bearing wheel bracket 133, the first connecting rod 131 is respectively hinged to the slider 122 and the fork arm 150, the two ends of the second connecting rod 132 are respectively hinged to the first connecting rod 131 and the load-bearing wheel bracket 133, the load-bearing wheel bracket 133 is respectively hinged to the fork arm 150 and the load-bearing wheel 140.

When the connecting rod mechanism 130 and the fork arm 150 are lifted relative to the forklift body 110, the first connecting rod 131 rotates relative to the fork arm 150 during the lifting process, thereby pushing the second connecting rod 132 to move rightward, the second connecting rod 132 pushes the load-bearing wheel bracket 133 to rotate relative to the fork arm 150, so that the load-bearing wheel 140 swings downward; when the connecting rod mechanism 130 and the fork arm 150 are lowered relative to the forklift body 110, the first connecting rod 131 rotates relative to the fork arm 150 during the lowering process, thereby pulling the second connecting rod 132 to move leftward, the second connecting rod 132 pulls the load-bearing wheel bracket 133 to rotate relative to the fork arm 150, so that the load-bearing wheel 140 swings upward.

In some optional embodiments, as shown in FIG. 1, the forklift 100 may further include an auxiliary support wheel 160, which may be arranged at the bottom of the forklift body 110, or at the bottom of the fork arm 150, or the auxiliary support wheel 160 may be arranged at the bottom of the forklift body 110 and the bottom of the fork arm 150. The auxiliary support wheel 160 can contact the ground to support the forklift body 110 or the fork arm 150, thereby improving the load capacity and stability of the forklift 100. The specific number of the auxiliary support wheels 160 may be one, two, or more than two. In actual settings, the number of the auxiliary support wheels 160 may be even, and the auxiliary support wheels may be symmetrically distributed on both sides of the forklift body 110 or the fork arm 150. This arrangement has a better support effect.

In some optional embodiments, as shown in FIG. 1, the forklift 100 includes two or more connecting rod mechanisms 130, the number of floating connection assemblies 120 and load-bearing wheels 140 is equal to the number of connecting rod mechanisms 130, and correspondingly, the number of fork arms 150 is also equal to the number of connecting rod mechanisms 130. Each load-bearing wheel 140 is hinged to the floating connection assembly 120 through the connecting rod mechanism 130, so that each load-bearing wheel 140 can float in the vertical direction to achieve a floating obstacle avoidance function.

1. A forklift, comprising: a forklift body (110), a floating connection assembly (120), a connecting rod mechanism (130) and a load-bearing wheel (140);
wherein the floating connection assembly (120) is arranged on the forklift body (110), one end of the connecting rod mechanism (130) is hinged to the floating connection assembly (120), and the other end of the connecting rod mechanism (130) is hinged to the load-bearing wheel (140) to support the load-bearing wheel (140);
wherein the floating connection assembly (120) has a first state and a second state;
wherein the floating connection assembly (120) can, when in the first state, float relative to the forklift body (110) in a vertical direction so that the connecting rod mechanism (130) and the load-bearing wheel (140) float relative to the forklift body (110) in the vertical direction;
wherein the floating connection assembly (120) is, when in the second state, relatively fixed to the forklift body (110) to limit the floating of the connecting rod mechanism (130) and the load-bearing wheel (140) relative to the forklift body (110) in the vertical direction.

2. The forklift of claim 1, wherein the floating connection assembly (120) comprises a sliding support seat (121) and a slider (122);
the sliding support seat (121) is slidably connected to the forklift body (110), and can slide relative to the forklift body (110) in the vertical direction, two opposite side walls of the sliding support seat (121) are respectively provided with a strip hole (1211), and the strip hole (1211) extends in the vertical direction;
one end of the connecting rod mechanism (130) is hinged to the slider (122), and the slider (122) is provided with a rotating shaft (1221), two ends of the rotating shaft (1221) are respectively inserted into the two strip holes (1211) so that the slider (122) can slide relative to the sliding support seat (121) in the vertical direction;
the sliding support seat (121) has a first position and a second position relative to the forklift body (110), when in the first position, the strip hole (1211) has a space for the rotating shaft (1221) to slide, and when in the second position, a hole wall of each of the strip holes (1211) abuts against the rotating shaft (1221) to limit the sliding of the rotating shaft (1221).

3. The forklift of claim 2, wherein the floating connection assembly (120) further comprises a driving member (123), the driving member (123) is arranged on the forklift body (110) and is connected to the sliding support seat (121) so as to drive the sliding support seat (121) to switch between the first position and the second position.

4. The forklift of claim 3, wherein an output end of the driving member (123) is provided with a hinge shaft (1231), the sliding support seat (121) is provided with an axis hole, the driving member (123) and the sliding support seat (121) are hinged by the fit between the hinge shaft (1231) and the axis hole.

5. The forklift of claim 2, wherein one of the sliding support seat (121) and the forklift body (110) is provided with a sliding groove (1212), and the other is provided with a sliding rail (111), the sliding groove (1212) and the sliding rail (111) extend in the vertical direction and form a sliding fit.

6. The forklift of claim 2, wherein the floating connection assembly (120) further comprises a shaft sleeve (124), the shaft sleeve (124) is respectively sleeved onto the both ends of the rotating shaft (1221) and is rotatably connected to the rotating shaft (1221), and an outer side of the shaft sleeve (124) is in sliding fit with the strip hole (1211).

7. The forklift of claim 2, wherein the forklift (100) further comprises a fork arm (150), the fork arm (150) is arranged corresponding to the connecting rod mechanism (130), and the load-bearing wheel (140) is used to support the fork arm (150);
the connecting rod mechanism (130) is hinged to the fork arm (150), and can raise and lower synchronously with the fork arm (150) relative to the forklift body (110).

8. The forklift of claim 7, wherein the connecting rod mechanism (130) comprises a first connecting rod (131), a second connecting rod (132) and a load-bearing wheel bracket (133);
the first connecting rod (131) is respectively hinged to the slider (122) and the fork arm (150), two ends of the second connecting rod (132) are respectively hinged to the first connecting rod (131) and the load-bearing wheel bracket (133), the load-bearing wheel bracket (133) is respectively hinged to the fork arm (150) and the load-bearing wheel (140).

9. The forklift of claim 7, wherein the forklift (100) further comprises an auxiliary support wheel (160), the auxiliary support wheel (160) is arranged at the bottom of the forklift body (110) and/or the fork arm (150).

10. The forklift of claim 1, wherein the forklift (100) comprises two or more connecting rod mechanisms (130), the number of the floating connection assembly (120) and the load-bearing wheel (140) is equal to the number of the connecting rod mechanism (130), each load-bearing wheel (140) is hinged to the floating connection assembly (120) via the connecting rod mechanism (130).
